(19) United States
(12) Patent Application Publication
(10) Pub. No.: US 2025/0007033 A1
(43) Pub. Date: Jan. 2, 2025

(54) BDU APPARATUS AND BATTERY PACK

(71) Applicant: EVE ENERGY CO., LTD., Huizhou (CN)

(72) Inventor: Hulong LIAO, Huizhou (CN)

(73) Assignee: EVE ENERGY CO., LTD., Huizhou (CN)

(21) Appl. No.: 18/679,210

(22) Filed: May 30, 2024

(30) Foreign Application Priority Data
Jun. 29, 2023 (CN) 202310787429.9
Jun. 29, 2023 (CN) 202321686751.4

(51) Int. Cl. H01M 10/6554; H01M 10/42; H01M 10/613; H01M 10/625; H01M 10/651; H01M 10/6567

(52) U.S. Cl. CPC H01M 10/6554; H01M 10/4257; H01M 10/613; H01M 10/651; H01M 10/6567; H01M 10/625

(57) ABSTRACT

The present disclosure discloses a BDU apparatus and a battery pack. The BDU apparatus includes a housing, an electrical component, one or more heat conducting members, and a cooling mechanism. The housing has an accommodating space. The electrical component is disposed in the accommodating space. The one or more heat conducting members are disposed in the housing and connected to the electrical component. The cooling mechanism is disposed on an outer side of the housing, wherein the electrical component exchanges heat with the cooling mechanism through the heat conducting members.

This application claims priority of Chinese Patent Application No. 202321686751.4, filed on Jun. 29, 2023, and priority of Chinese Patent Application No. 202310787429.9, filed on Jun. 29, 2023. The disclosures of the above applications are incorporated herein by reference in their entireties.

### TECHNICAL FIELD

The present disclosure relates to the field of battery technologies, and specifically, to a BDU apparatus and a battery pack.

### BACKGROUND

A Battery Energy Distribution Unit (BDU), also referred to as a battery disconnect unit, as a special distribution box for an electric vehicle power battery, may provide one or more functions such as pre-charging, super charging, discharge control, circuit overload and short-circuit protection, high-voltage sampling, and low-voltage control for a high-voltage system of a new energy vehicle, to protect and monitor operation of the high-voltage system.

In the related art, with the development of high-voltage, high-current, and super-fast charging battery packs, due to poor heat dissipation of a BDU apparatus, there is a need to select electrical components with a great current-carrying capacity and a higher specification such as a fuse, a relay, and the like. As a result, the BDU apparatus is large in size, and occupies more space in the battery pack, which increases a weight and a cost of the battery pack.

### SUMMARY

According to a first aspect, some embodiments of the present disclosure provide a Battery Energy Distribution Unit (BDU) apparatus, including:
a housing having an accommodating space;
an electrical component disposed in the accommodating space;
one or more heat conducting members disposed in the housing and connected to the electrical component; and
a cooling mechanism disposed on an outer side of the housing, wherein the electrical component exchange heat with the cooling mechanism through the heat conducting members.

According to a second aspect, some embodiments of the present disclosure provide a battery pack, including the BDU apparatus.

### BRIEF DESCRIPTION OF THE DRAWINGS

To describe the technical solutions in the embodiments of the present disclosure more clearly, the following briefly introduces the accompanying drawings required for describing the embodiments. Apparently, the accompanying drawings in the following description show only some embodiments of the present disclosure, and a person of ordinary skill in the art may still derive other accompanying drawings from these accompanying drawings without creative efforts.

FIG. 1 is a three-dimensional schematic diagram of a Battery Energy Distribution Unit (BDU) apparatus according to some embodiments of the present disclosure.

FIG. 2 is an exploded view of a BDU apparatus according to some embodiments of present disclosure.

FIG. 3 is a three-dimensional schematic diagram of a housing part of a BDU apparatus according to some embodiments of the present disclosure.

FIG. 4 is an enlarged view of a part A in FIG. 3.

FIG. 5 is a three-dimensional schematic diagram of a liquid cooling plate of a BDU apparatus according to some embodiments of the present disclosure.

FIG. 6 is a three-dimensional schematic diagram of a heat conducting member of a BDU apparatus according to some embodiments of the present disclosure.

FIG. 7 is a side view of a BDU apparatus according to some embodiments of present disclosure.

FIG. 8 is a cross-sectional view of B-B in FIG. 7.

FIG. 9 is an enlarged view of a part C in FIG. 8.

### LIST OF REFERENCE NUMERALS

100—housing, 110—base, 120—cover plate, 121—limiting hole, 122—limiting protrusion, 123—screw hole, 124—electrical avoidance hole, 130—accommodating space, 140—mounting plate, 150—cushion pad mounting pin, 160—buckle, 161—buckle sleeve, 162—buckle protrusion, 200—electrical component, 210—copper busbar, 300—heat conducting member, 310—flat plate portion, 320—recessed portion, 321—notch, 400—cooling mechanism, 410—liquid cooling plate, 420—insulating protrusion, 430—water inlet connector, 440—water outlet connector, and 500—insulating heat conducting layer.

### DETAILED DESCRIPTION

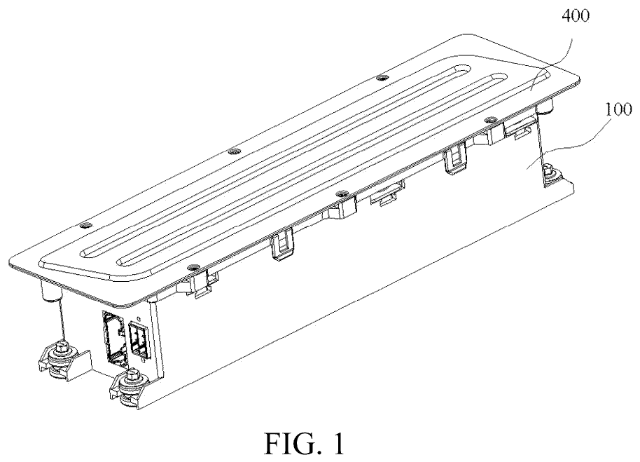

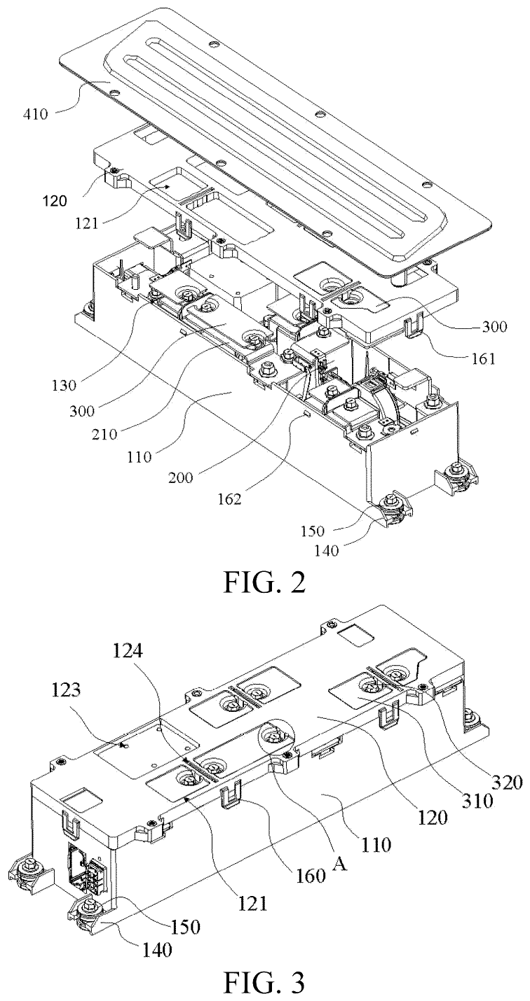

Referring to FIG. 1 and FIG. 2, FIG. 1 is a three-dimensional view of a Battery Energy Distribution Unit (BDU) apparatus according to some embodiments of the present disclosure, and FIG. 2 is an exploded view of a BDU apparatus according to some embodiments of present disclosure.

Some embodiments of the present disclosure provide a BDU apparatus, including a housing such as a housing 100, a plurality of electrical components such as an electrical component 200, heat conducting members such as one or more heat conducting members 300, and a cooling mechanism such as a cooling mechanism 400.

The housing 100 includes a base such as a base 110 and a cover plate such as a cover plate 120. The base 110 is a rectangular box structure, and a groove is provided in the base 110. The base 110 may be made of a plastic material, and has an insulating function to avoid current leakage. The cover plate 120 is a rectangular flat plate. The cover plate 120 is made of a plastic material, and has an insulating function to avoid current leakage. A size of the cover plate 120 is adapted to match a size of the base 110. The base 110 is connected to the cover plate 120, which is covered on an opening of the groove of the base 110. An enclosure of the base 110 and the cover plate 120 form an accommodating space 130. A plurality of interfaces of a high-voltage circuit are disposed on a side surface of the base 110. The plurality of interfaces may include a positive input interface, a negative input interface, a positive output interface, and a negative output interface. The positive input interface and the negative input interface are respectively electrically connected to a positive electrode and a negative electrode of a cell of a power battery. A wire groove is provided on a side of the base 110 away from the cover plate 120. A plurality of mounting plates 140 are disposed at positions on an outer side of the base 110 close to two ends of the base 110, such as four mounting plates 140. Two mounting plates 140 are disposed at one of the two ends of the base 110, and the two mounting plates 140 located at the one end are close to two sides of the base 110. Each mounting plate 140 is connected to a battery box through a cushion pad mounting pin 150. The BDU apparatus may be fixed in the battery box through the mounting plate 140 and the cushion pad mounting pin 150. A mounting operation is simple, and the cushion pad mounting pin 150 may play a shock-absorbing role, to prevent the electrical component 200 in the BDU apparatus from shaking, and ensure reliable connection of the electrical component 200.

The electrical component 200 is a relay and a fuse. The electrical component 200 is electrically connected through a copper busbar 210 to form a high-voltage circuit. The relay receives a signal through a low-voltage wire harness to switch on or off the high-voltage circuit, transfers a voltage signal through the high-voltage wire harness, and performs insulation monitoring and detects states of the fuse and the relay. A plurality of electrical components 200 are disposed in the accommodating space 130, and a side of each electrical component 200 close to the cover plate 120 is connected through the copper busbar 210. The housing 100 made of the insulating material is used to mount the electrical components 200, to avoid current leakage of the BDU apparatus, and ensure security and reliability of the BDU during use.

The heat conducting member(s) 300 is made of a material with a high heat conducting coefficient. The heat conducting member 300 is connected to the copper busbar 210 of the electrical component 200 and the cover plate 120. A heat conducting coefficient of the heat conducting member 300 is higher than a heat conducting coefficient of the copper busbar 210, and heat generated by the electrical component 200 is transferred from the copper busbar 210 through the heat conducting member 300. One copper busbar 210 of the electrical component 200 corresponds to one heat conducting member 300, which ensures a heat conducting effect while avoiding a short circuit or current leakage.

The cooling mechanism 400 is connected to the cover plate 120. The cooling mechanism 400 is located on a side of the cover plate 120 away from the base 110. The heat conducting members 300 exchange heat with the cooling mechanism 400, so as to take away the heat of the heat conducting members 300, thereby dissipate heat of the electrical component 200 of the BDU apparatus. The electrical component 200 is mounted inside the housing 100, and the cooling mechanism 400 is located outside the housing 100, which ensures the heat dissipation of the BDU, and eliminates the need to enlarge the housing 100. The BDU apparatus is small and light as a whole, has a low cost, occupies a small space in a battery pack, and may meet requirements of the battery pack like a high voltage, a high current, and super-fast charging.

Referring to FIG. 1, FIG. 2, and FIG. 5, FIG. 5 is a three-dimensional schematic diagram of a liquid cooling plate of a BDU apparatus according to some embodiments of the present disclosure.

In some embodiments, the cooling mechanism 400 includes a liquid cooling plate 410. The liquid cooling plate 410 is in a shape of a rectangular plate. The liquid cooling plate 410 has a first side surface and a second side surface. The first side surface faces the cover plate 120, and the second side surface faces away from the cover plate 120. A water inlet connector 430 and a water outlet connector 440 are disposed on the liquid cooling plate 410. The water inlet connector 430 and the water outlet connector 440 are disposed at positions close to two ends of the liquid cooling plate 410. The water inlet connector 430 and the water outlet connector 440 are disposed on the first side surface. The liquid cooling plate 410 is connected to the cover plate 120. The liquid cooling plate 410 is located on a side of the cover plate 120 away from the base 110. A size of the liquid cooling plate 410 is greater than a size of the cover plate 120. The water inlet connector 430 and the water outlet connector 440 are located outside the housing 100, and the liquid cooling plate 410 performs heat exchange with the heat conducting members 300. The liquid cooling plate 410 may generate condensation during operation. The liquid cooling plate 410 is separated from the accommodating space 130 through the cover plate 120, to prevent the condensation from dripping into the accommodating space 130, thereby protecting the electrical component 200 and improving reliability of the BDU apparatus.

In some embodiments, referring to FIG. 2, a plurality of limiting holes 121 are provided on the cover plate 120. A quantity of limiting holes 121, a quantity of heat conducting members 300, and a quantity of copper busbars 210 are in a one to one correspondence. The limiting holes 121 are respectively in alignment with the heat conducting members 300. Each of the heat conducting members 300 is connected to the electrical component 200 and the liquid cooling plate 410. A shape and a size of a limiting hole 121 are adapted to match a shape and a size of a part of a corresponding heat conducting member 300 in the limiting hole 121. A region on the cover plate 120 between adjacent heat conducting members 300 is a solid part, to prevent the limiting hole 121 from being too large, which causes the condensation to enter the accommodating space 130 from the limiting hole 121. The limiting hole 121 further limits and fixes the heat conducting member 300. The heat conducting member 300 passes through the limiting hole 121 and is connected to the liquid cooling plate 410, to improve the heat conducting effect.

In some embodiments, a gap between a hole wall of each of the limiting holes 121 and a corresponding heat conducting member 300 may be further filled with a sealant, to prevent the condensation from directly dripping into the accommodating space 130, thereby protecting the electrical component 200 and improving reliability of the BDU apparatus.

In some embodiments, an insulating heat conducting layer 500 is disposed between the heat conducting members 300 and the liquid cooling plate 410. The insulating heat conducting layer 500 covers a contact position between the heat conducting members 300 and the liquid cooling plate 410. The insulating heat conducting layer 500 may avoid a gap between the heat conducting member 300 and the liquid cooling plate 410, which avoids affecting the heat dissipation effect. In addition, the insulating heat conducting layer 500 has an insulating characteristic, preventing current leakage of the heat conducting member 300. In this way, the insulating heat conducting layer 500 plays the role of insulation and heat transfer.

The insulating heat conducting layer 500 may be made of glue with a heat conducting coefficient above 1.5 W/m·k, low temperature tolerance below −40° C., high temperature tolerance above 150° C., fire protection grade meeting UL94V-0, and a dielectric strength greater than 1.414×(2U+1000)Vdc/mm, wherein U represents the maximum operating voltage of the BDU apparatus. A thickness of the insulating heat conducting layer 500 ranges from 1 mm to 2 mm, which plays an insulating protective effect and ensures electrical security.

In some embodiments, a side surface of the liquid cooling plate 410 close to the cover plate 120 is coated with an insulating layer. A thickness of the insulating layer may reach 200 m. The insulating layer is formed by spraying insulating paint. The insulating layer plays an insulating protective effect and ensures electrical security.

In some embodiments, one or more screw holes 123 are further provided on the cover plate 120, and a gap between a hole wall of each of the screw hole 123 and a corresponding screw is filled with a sealant. This prevents the condensation from entering an interior of the housing 100 from the screw hole 123, and protects the electrical component 200.

In some embodiments, one or more electrical avoidance holes 124 for exposing the electrical component 200 are further provided on the cover plate 120, and a gap between a hole wall of each of the electrical avoidance holes 124 and the electrical component 200 is filled with a sealant. This prevents the condensation from entering an interior of the housing 100 from the electrical avoidance hole 124, to prevent the condensation from entering the interior of the housing 100 from the electrical avoidance hole 124 while ensuring a sufficient mounting space for the electrical component 200, thereby protecting the electrical component 200.

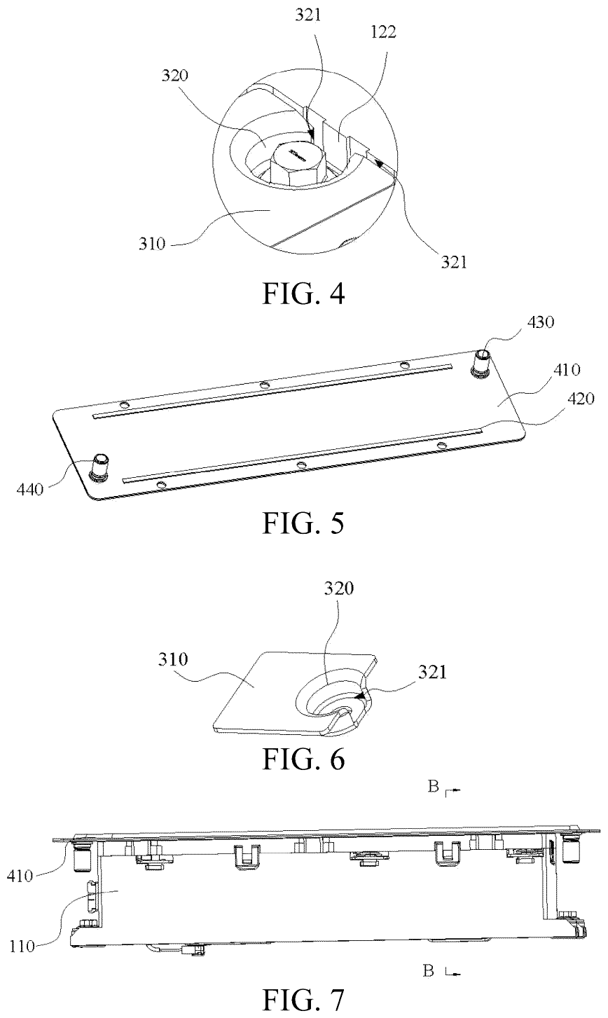

Referring to FIG. 3, FIG. 4, and FIG. 6, FIG. 3 is a three-dimensional schematic diagram of a housing part of a BDU apparatus according to some embodiments of the present disclosure, FIG. 4 is an enlarged view of a part A in FIG. 3, and FIG. 6 is a three-dimensional schematic diagram of a heat conducting member of a BDU apparatus according to some embodiments of the present disclosure.

In some embodiments, the heat conducting member 300 includes a flat plate portion 310 and a recessed portion 320 that are connected to each other. The flat plate portion 310 is located in the limiting hole 121, and a size of the flat plate portion 310 is adapted to match a size of the limiting hole 121. A gap between the flat plate portion 310 and an inner wall of the limiting hole 121 may be filled with a sealant, to prevent the condensation from dripping into the accommodating space 130 and ensure electrical reliability. The flat plate portion 310 is connected to the liquid cooling plate 410. The flat plate portion 310 may be directly attached to the cover plate 120, or may be attached to the cover plate 120 through an insulating heat conducting layer. The recessed portion 320 is recessed toward a side away from the liquid cooling plate 410, and a bottom of the recessed portion 320 is attached and connected to the copper busbar 210 of the electrical component 200. The heat conducting member 300 is connected to the copper busbar 210 of the electrical component 200 through a screw. An end of the screw is located in the recessed portion 320, which facilitates assembly of the heat conducting member 300 and the copper busbar 210 of the electrical component 200, and also prevents the screw from contacting the liquid cooling plate 410.

An area of the flat plate portion 310, a contact area between the recessed portion 320 and the copper busbar 210, and a depth of the recessed portion 320 are designed according to thermal conductivity of the heat conducting member 300, a temperature of the liquid cooling plate 410, and a temperature of the copper busbar 210. The area of the flat plate portion 310, the contact area between the recessed portion 320 and the copper busbar 210, and the depth of the recessed portion 320 at different positions are not necessarily the same.

In some embodiments, referring to FIG. 4, the recessed portion 320 has a notch 321, and an edge of the notch 321 is flush with an end of the flat plate portion 310. It may be understood that the notch 321 is U-shaped, and the notch 321 and the end of the flat plate portion 310 are located on the same plane. By providing the heat conducting member 300 with the notch 321, it is ensured that there is no interference between the heat conducting member 300 and electrical components 200, such as sidings of electric relay.

Base on the foregoing embodiments, referring to FIG. 4, a limiting protrusion 122 is disposed on the cover plate 120, the limiting protrusion 122 is located in the limiting hole 121, and the limiting protrusion 122 is disposed in alignment with the notch 321.

It may be understood that the limiting protrusion 122 protrudes from the side wall of the limiting hole 121 to an interior of the limiting hole 121. A size and a position of the limiting protrusion 122 correspond to a size and a position of the notch 321. When the flat plate portion 310 is located in the limiting hole 121, the notch 321 corresponds to the limiting protrusion 122, and the limiting protrusion 122 is located in the notch 321. The limiting protrusion 122 is engaged with the notch 321, to prevent the heat conducting member 300 from rotating in an axis direction of the recessed portion 320, and to locate a mounting position of the heat conducting member 300 on the cover plate 120, facilitating an assembly operation of the user.

In some embodiments, referring to FIG. 4, a height of a side surface of the flat plate portion 310 away from the electrical component 200 is less than or equal to a height of a side surface of the cover plate 120 away from the base 110. For example, as shown in FIG. 9, taking a plane on which a side surface of the heat conducting member 300 close to the copper busbar 210 is located as an exemplary reference plane, a height H1 of the side surface of the flat plate portion 310 away from the electrical component 200 relative to the reference plane is less than a height H2 of the side surface of the cover plate 120 away from the base 110 relative to the reference plane.

It may be understood that a specific distance is reserved between the side surface of the flat plate portion 310 away from the recessed portion 320 and the side surface of the cover plate 120 away from the base 110. A specific distance is reserved between an upper surface of the flat plate portion 310 and an upper surface of the cover plate 120. The distance may be 0.3 mm, to prevent the heat conducting member 300 from protruding from the upper surface of the cover plate 120, which is beneficial to forming an insulating heat conducting layer 500 between the heat conducting member 300 and the liquid cooling plate 410, ensuring a thickness of a glue layer, and improving the insulating heat conducting effect.

In some embodiments, referring to FIG. 5, an insulating protrusion 420 is disposed on a side surface of the liquid cooling plate 410 close to the cover plate 120, and the insulating protrusion 420 bulges toward the cover plate 120. The insulating protrusion 420 is in a shape of a long strip, and the insulating protrusion 420 extends in a length direction of the liquid cooling plate 410. Two insulating protrusions 420 are disposed. The two insulating protrusions 420 are located close to two sides of the cover plate 120, respectively. The insulating protrusions 420 are made of a plastic material, and a thickness of the insulating protrusion 420 may be 0.3 mm. A side surface of the insulating protrusion 420 away from the liquid cooling plate 410 is attached to the upper surface of the cover plate 120, to ensure that there is a gap of at least 0.3 mm between the liquid cooling plate 410 and the cover plate 120. Even if the upper surface of the heat conducting member 300 is flush with the upper surface of the cover plate 120, there is enough space to form an insulating heat conducting layer.

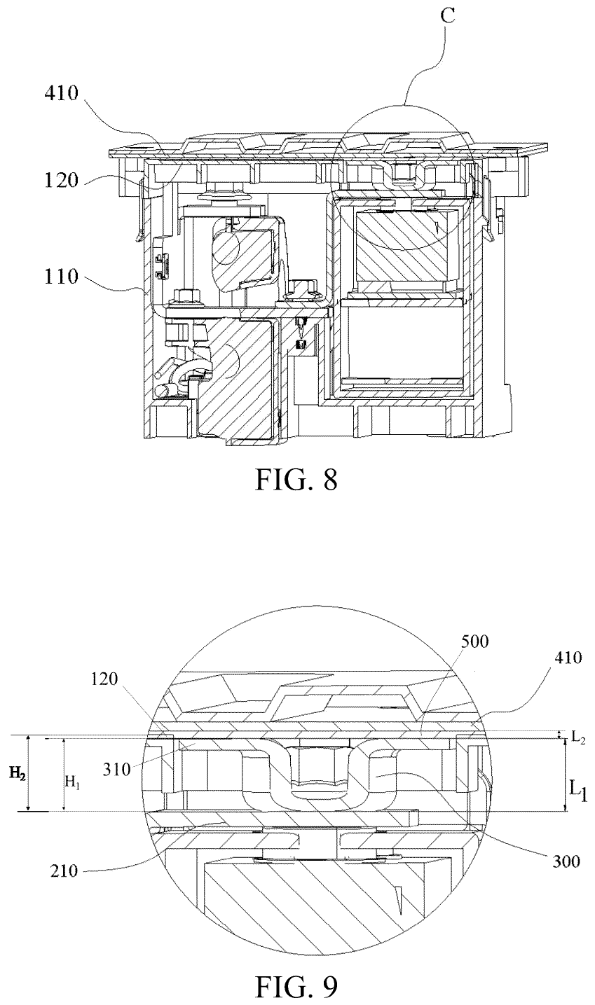

Referring to FIG. 7, FIG. 8, and FIG. 9, FIG. 7 is a side view of a BDU apparatus according to some embodiments of present disclosure, FIG. 8 is a cross-sectional view of B-B in FIG. 7, and FIG. 9 is an enlarged view of a part C in FIG. 8.

In some embodiments, a first heat conducting distance between a side of the heat conducting member 300 close to the cooling mechanism 400 and a side of the heat conducting member 300 close to the copper busbar 210 is L₁, wherein 0<L₁≤90 mm.

It may be understood that the first heat conducting distance L₁ is a distance between a lower surface and an upper surface of the heat conducting member 300. In other words, a distance between a plane on which the upper surface of the flat plate portion 310 is located and a plane on which the lower surface of the recessed portion 320 is located. The heat of the copper busbar 210 is transferred to the cooling mechanism 400 through the heat conducting member 300, thereby cooling the copper busbar 210. A specific value of the first heat conducting distance L₁ depends on a position of the copper busbar 210. If the copper busbar 210 is close to the cover plate 120, the first heat conducting distance L₁ is less. If the copper busbar 210 is close to a bottom of the base 110, the first heat conducting distance L₁ is great. The less the first heat conducting distance L₁, the less the time required for the heat of the copper busbar 210 to be transferred to the cooling mechanism 400. In a limited range, the less the first heat conducting distance L₁ is designed, the better the heat dissipation effect is.

In some embodiments, referring to FIG. 9, a second heat conducting distance between a side of the flat plate portion 310 away from the copper busbar 210 and the liquid cooling plate 410 is L₂, wherein 0<L₂≤4 mm.

It may be understood that the second heat conducting distance L₂ refers to a distance between the upper surface of the flat plate portion 310 and the lower surface of the liquid cooling plate 410. When an insulating heat conducting layer 500 is disposed between the liquid cooling plate 410 and the flat plate portion 310, the second heat conducting distance L₂ is a thickness of the insulating heat conducting layer 500. The second heat conducting distance L₂ may be 0.5 mm, 1 mm, 2 mm, 3 mm, 4 mm, or other unspecified data. The less the second heat conducting distance L₂, the less the time required for the heat of the copper busbar 210 to be transferred to the cooling mechanism 400 and the better the heat dissipation effect. 0<L₂≤4 mm is set, which meets a requirement of insulation while taking into account the heat conducting effect, and the design is proper.

In some embodiments, referring to FIG. 2 and FIG. 3, the cover plate 120 is connected to the base 110 through a buckle 160.

The buckle 160 includes a buckle sleeve 161 and a buckle protrusion 162. The buckle sleeve 161 is in a shape of a rectangle, and the buckle sleeve 161 has a hole corresponding to the buckle protrusion 162. The buckle sleeve 161 is disposed on a side surface of the cover plate 120, the buckle protrusion 162 is disposed on a side surface of the base 110, and the buckle sleeve 161 is arranged in alignment with the buckle protrusion 162. A cross-sectional shape of the buckle protrusion 162 is a right-angled triangle, a vertex of the triangle is close to the cover plate 120, and a right-angled side of the triangle is attached to the side surface of the base 110, which is convenient for the buckle protrusion 162 to enter a hole of the buckle sleeve 161 from a hypotenuse, so that the buckle protrusion 162 and the buckle sleeve 161 may be engaged together, and the buckle is firm. When the buckle protrusion 162 and the buckle sleeve 161 are in an engaged state, the buckle protrusion 162 is located in the buckle sleeve 161. Both the buckle sleeve 161 and the buckle protrusion 162 are made of a plastic material. The buckle sleeve 161 has a specific elasticity degree, and a plurality of buckles 160 are spaced apart in a circumferential direction of the housing 100. The cover plate 120 and the base 110 are fixed through the buckle 160, to facilitate assembly and disassembly.

As a variant, the cover plate 120 and the base 110 may be connected by a bolt. For example, a plurality of ear plates protruding toward an outside of the housing 100 are disposed on both the cover plate 120 and the base 110. Screw holes are provided on the ear plate and an edge of the liquid cooling plate 410. The edge of the liquid cooling plate 410, the ear plate of the cover plate 120, and the ear plate of the base 110 are sequentially attached and fixedly connected through the screw.

In some embodiments, the BDU apparatus further includes a protection system. The protection system includes a temperature sensor and a controller. The temperature sensor and cooling mechanism 400 are connected to the controller. The temperature sensor is disposed in the base 110. The temperature sensor is disposed at a position with the highest temperature in the accommodating space 130. The temperature sensor is configured to collect a temperature value at the position in real time, and send the temperature value to the controller in real time. The controller controls an operation of the cooling mechanism 400 according to the temperature value, to ensure that the BDU operates reliably in a secure temperature range.

Insulation processing is performed on an OT terminal of the temperature sensor. For example, encapsulation is performed on the OT terminal with epoxy resin, to prevent the temperature sensor from directly contacting the electrical component 200 in the accommodating space 130 and thereby causing a short circuit.

In some embodiments, the BDU apparatus further includes a condensation detection apparatus disposed in the accommodating space 130 or on a side of the cover plate 120 away from the base 110. The condensation detection apparatus is configured to detect a condensation parameter of the BDU apparatus in real time. The condensation detection apparatus is connected to the controller. The controller is configured to send alarm information when the condensation parameter is greater than a preset threshold, which may effectively prevent the BDU apparatus from occurring due to insulation failure. The condensation detection apparatus may be a liquid sensor.

Some embodiments of the present disclosure further provide a battery pack, including the BDU apparatus. The BDU apparatus includes a housing such as a housing 100, a plurality of electrical components such as an electrical component 200, a heat conducting member such as one or more heat conducting members 300, and a cooling mechanism such as a cooling mechanism 400.

The housing 100 includes a base such as a base 110 and a cover plate such as a cover plate 120. The base 110 is a rectangular box structure, and a groove is provided in the base 110. The base 110 may be made of a plastic material, and has an insulating function, to avoid current leakage. The cover plate 120 is a rectangular flat plate. The cover plate 120 is made of a plastic material, and has an insulating function to avoid current leakage. A size of the cover plate 120 is adapted to match a size of the base 110. The base 110 is connected to the cover plate 120, and covers an opening of the groove of the base 110. An enclosure of the base 110 and the cover plate 120 form an accommodating space 130. A plurality of interfaces of a high-voltage circuit are disposed on a side surface the base 110. The plurality of interfaces may include a positive input interface, a negative input interface, a positive output interface, and a negative output interface. The positive input interface and the negative input interface are respectively electrically connected to a positive electrode and a negative electrode of a cell of a power battery. A wire groove is provided on a side of the base 110 away from the cover plate 120. A plurality of mounting plates 140 are disposed at positions on an outer side of the base 110 close to two ends of the base 110, such as four mounting plates 140. Two mounting plates 140 are disposed at one of the two ends of the base 110, and the two mounting plates 140 located at the one end are close to two sides of the base 110. Each mounting plate 140 is connected to a battery box through a cushion pad mounting pin 150. The BDU apparatus may be fixed in the battery box through the mounting plate 140 and the cushion pad mounting pin 150. A mounting operation is simple, and the cushion pad mounting pin 150 may play a shock-absorbing role, to prevent the electrical component 200 in the BDU apparatus from shaking, and ensure reliable connection of the electrical component 200.

The electrical components 200 are a relay and a fuse. The electrical component 200 is electrically connected through a copper busbar 210 to form a high-voltage circuit. The relay receives a signal through a low-voltage wire harness to switch on or off the high-voltage circuit, transfers a voltage signal through the high-voltage wire harness, and performs insulation monitoring, and detects states of the fuse and the relay. A plurality of electrical components 200 are disposed in the accommodating space 130, and a side of each electrical component 200 close to the cover plate 120 is connected through the copper busbar 210. The housing 100 made of the insulating material is used to mount the electrical components 200, to avoid current leakage of the BDU apparatus, and ensure security and reliability of the BDU during use.

The heat conducting member(s) 300 is made of a material with a high heat conducting coefficient. The heat conducting member 300 is connected to the copper busbar 210 and the cover plate 120 of the electrical component 200. A heat conducting coefficient of the heat conducting member 300 is higher than a heat conducting coefficient of the copper busbar 210, and heat generated by the electrical component 200 is transferred from the copper busbar 210 through the heat conducting member 300. One copper busbar 210 of the electrical component 200 corresponds to one heat conducting member 300, which ensures a heat conducting effect while avoiding a short circuit or current leakage.

The cooling mechanism 400 is connected to the cover plate 120. The cooling mechanism 400 is located on a side of the cover plate 120 away from the base 110. The heat conducting members 300 exchange heat with the cooling mechanism 400, so as to take away the heat of the heat conducting members 300, thereby dissipate heat of the electrical component 200 of the BDU apparatus. The electrical component 200 is mounted inside the housing 100, and the cooling mechanism 400 is located outside the housing 100, which ensures the heat dissipation of the BDU, and eliminates the need to enlarge the housing 100. The BDU apparatus is small and light as a whole, has a low cost, occupies a small space in a battery pack, and may meet requirements of the battery pack like a high voltage, a high current, and super-fast charging.

In the foregoing embodiments, the descriptions of the embodiments have their respective focuses. For a part that is not described in detail in some embodiments, reference may be made to related descriptions in other embodiments.

The terms “first” and “second” in descriptions of the present disclosure are merely intended for a purpose of description, and shall not be understood as an indication or implication of relative importance or implicit indication of a quantity of indicated technical features. Therefore, a feature limited by “first” or “second” may explicitly or implicitly include one or more features.

What is claimed is:

1. A Battery Energy Distribution Unit (BDU) apparatus, comprising:
a housing having an accommodating space;
an electrical component disposed in the accommodating space;
one or more heat conducting members disposed in the housing and connected to the electrical component; and
a cooling mechanism disposed on an outer side of the housing, wherein the electrical component exchanges heat with the cooling mechanism through the heat conducting members.

2. The BDU apparatus as claimed in claim 1, wherein the cooling mechanism comprises a liquid cooling plate connected to the housing.

3. The BDU apparatus as claimed in claim 2, wherein an insulating heat conducting layer is disposed between the heat conducting members and the liquid cooling plate, and the insulating heat conducting layer covers a contact position between the heat conducting members and the liquid cooling plate.

4. The BDU apparatus as claimed in claim 2, wherein a plurality of limiting holes are provided on the housing,
the limiting holes are respectively in alignment with the heat conducting members, each heat conducting member of the heat conducting members is located in a corresponding one of the limiting holes, and
the each heat conducting member is connected to the electrical component and the liquid cooling plate.

5. The BDU apparatus as claimed in claim 4, wherein the each heat conducting member comprise a flat plate portion and a recessed portion that are connected to each other,
the flat plate portion is located in the corresponding one of the limiting holes and is connected to the cooling mechanism,
the recessed portion is recessed toward a side away from the cooling mechanism, and the recessed portion is attached and connected to a copper busbar of the electrical component.

6. The BDU apparatus as claimed in claim 5, wherein the recessed portion has a notch, and an edge of the notch is flush with an end of the flat plate portion.

7. The BDU apparatus as claimed in claim 6, wherein a plurality of limiting protrusions is disposed on the housing and are respectively located in the limiting holes, and one of the limiting protrusions located in the corresponding one of the limiting holes is disposed in alignment with the notch.

8. The BDU apparatus as claimed in claim 5, wherein a height of a side surface of the flat plate portion away from the electrical component is less than or equal to a height of a side surface of the housing close to the cooling mechanism.

9. The BDU apparatus as claimed in claim 5, wherein a first heat conducting distance between a side of the each heat conducting member close to the cooling mechanism and a side of the each heat conducting member close to the copper busbar is L₁, wherein 0<L₁≤90 mm; and/or
a second heat conducting distance between a side of the flat plate portion away from the copper busbar and the liquid cooling plate is L₂, wherein 0<L₂≤4 mm.

10. The BDU apparatus as claimed in claim 4, wherein one or more screw holes are provided on the housing, and a gap between a hole wall of each of the screw holes and a corresponding screw is filled with a sealant; and/or
one or more electrical avoidance holes for exposing the electrical component is provided on the housing, and a gap between a hole wall of each of the electrical avoidance holes and the electrical component is filled with a sealant; and/or
a gap between a hole wall of each of the limiting holes and a corresponding one of the heat conducting members is filled with a sealant.

11. The BDU apparatus as claimed in claim 2, wherein an insulating protrusion is disposed on a side surface of the liquid cooling plate close to the housing, and the insulating protrusion is connected to the housing; and/or
an insulating layer is disposed on a side surface of the liquid cooling plate facing the housing.

12. The BDU apparatus as claimed in claim 1, wherein the housing comprises a base and a cover plate, the base is connected to the cover plate to form the accommodating space, and the cooling mechanism is located on a side of the cover plate away from the base.

13. The BDU apparatus as claimed in claim 12, wherein the cover plate is connected to the base through a buckle.

14. A battery pack, comprising a Battery Energy Distribution Unit (BDU) apparatus, wherein the BDU apparatus comprises:
a housing having an accommodating space;
an electrical component disposed in the accommodating space;
one or more heat conducting members disposed in the housing and connected to the electrical component; and
a cooling mechanism disposed on an outer side of the housing, wherein the electrical component exchanges heat with the cooling mechanism through the heat conducting members.

15. The battery pack as claimed in claim 14, wherein the cooling mechanism comprises a liquid cooling plate connected to the housing.

16. The battery pack as claimed in claim 15, wherein an insulating heat conducting layer is disposed between the heat conducting members and the liquid cooling plate, and the insulating heat conducting layer covers a contact position between the heat conducting members and the liquid cooling plate.

17. The battery pack as claimed in claim 15, wherein a plurality of limiting holes is provided on the housing,
the limiting holes are respectively in alignment with the heat conducting members, each heat conducting member of the heat conducting members is located in a corresponding one of the limiting holes, and
the each heat conducting member is connected to the electrical component and the liquid cooling plate.

18. The battery pack as claimed in claim 17, wherein the each heat conducting member comprises a flat plate portion and a recessed portion that are connected to each other,
the flat plate portion is located in the corresponding one of the limiting holes and is connected to the cooling mechanism,
the recessed portion is recessed toward a side away from the cooling mechanism, and the recessed portion is attached and connected to a copper busbar of the electrical component.

19. The battery pack as claimed in claim 18, wherein the recessed portion has a notch, and an edge of the notch is flush with an end of the flat plate portion.

20. The battery pack as claimed in claim 19, wherein a plurality of limiting protrusions is disposed on the housing and are respectively located in the limiting holes, and one of the limiting protrusions located in the corresponding one of the limiting holes is disposed in alignment with the notch.
